(19) United States
(12) Patent Application Publication
(10) Pub. No.: US 2026/0127515 A1
(43) Pub. Date: May 7, 2026

(54) Smart Incident Response

(71) Applicant: PagerDuty, Inc., San Francisco, CA (US)

(72) Inventors: Sanghamitra Goswami, Chicago, IL (US); Laura Ann Zuchlewski, Shoreline, WA (US)

(21) Appl. No.: 19/374,843

(22) Filed: Oct. 30, 2025

Related U.S. Application Data
(63) Continuation of application No. 17/876,727, filed on Jul. 29, 2022, now abandoned.

(51) Int. Cl. G06Q 10/0631

(52) U.S. Cl. CPC G06Q 10/06311

(57) ABSTRACT

An event management bus is configured to ingest events from a plurality of monitoring tools at a defined acceptance rate. Events received in excess of the acceptance rate are rejected, and a rejection notification is transmitted. For an ingested event, an incident is triggered. A machine-learning model, selected based on a determined incident type, initiates a process to identify a resolution for the incident. An action determined as a result of the process is executed by an action execution tool. Feedback data indicating the effectiveness of the executed action in resolving the incident is received. The machine-learning model is then retrained using the feedback data.

### CROSS-REFERENCE TO RELATED APPLICATIONS

This disclosure claims the benefit of U.S. Patent Application No. 17/876,727 filed July 29, 2022, the disclosure of which is incorporated by reference herein in its entirety.

### BACKGROUND

Information technology (IT) systems are increasingly becoming complex, multivariate, and in some cases non-intuitive systems with varying degrees of nonlinearity. These complex IT systems may be difficult to model or accurately understand. Various monitoring systems may be arrayed to provide events, alerts, notifications, or the like, in an effort to provide visibility into operational metrics, failures, and/or correctness. However, the sheer size and complexity of these IT systems may result in a flooding of disparate event messages from disparate monitoring/reporting services.

With the increased complexity of distributed computing systems existing event reporting and/or management may not, for example, have the capability to effectively process events in complex and noisy systems. At enterprise scale, IT systems may have millions of components resulting in a complex inter-related set of monitoring systems that report millions of events from disparate subsystems. Manual techniques and pre-programmed rules are labor and computing intensive and expensive, especially in the context of large, centralized IT Operations with very complex systems distributed across large numbers of components. Further, these manual techniques may limit the ability of systems to scale and evolve for future advances in IT systems capabilities

In networked environments, network operators retain a certain number of responders to address incidents in networked systems and applications. A responder assigned to resolve an incident may need assistance from other responders.

### SUMMARY

Disclosed herein are implementations of a system and method for responding to alerts in a networked environment.

In an aspect, a method for managing event data in an event management system is disclosed. The method includes configuring an event management bus to ingest one or more events from a plurality of disparate monitoring tools limited to a defined acceptance rate, rejecting a received event in response to determining that the received event is not received in accordance with the defined acceptance rate, and transmitting a rejection notification to a system from which the received event was received in response to the determining, wherein the rejection notification indicates that the received event is not accepted for processing. The method includes triggering an incident for an event ingested in accordance with the defined acceptance rate, initiating, based on an output from a machine-learning model, a process for identifying a resolution for the incident, wherein the machine-learning model is selected based on an incident type determined for the incident, executing an action determined as a result of the initiated process by an action execution tool, receiving feedback data from the action execution tool indicating an effectiveness of the executed action in resolving the incident, and retraining the machine-learning model using the feedback data.

In a second aspect, a method for managing event data in an event management system is disclosed. The method includes configuring an event management bus to ingest one or more events at a defined acceptance rate and to reject any event received in excess of the defined acceptance rate, classifying a corresponding incident as one of at least a frequent type or a rare type for an ingested event, and executing a collaborative filtering model to initiate a process to identify an action for resolving the incident, responsive to the incident being classified as the frequent type. The method includes executing a content-based filtering model to initiate a process to identify the action for resolving the incident, responsive to the incident being classified as the rare type, tracking feedback data resulting from the action being carried out, and retraining at least one of the collaborative filtering model or the content-based filtering model using the feedback data to improve one or more subsequent action recommendations.

In a third aspect, a method for improving incident response is disclosed. The method includes configuring an event management bus to ingest one or more received events, wherein each received event indicates a condition detected by a monitoring tool, and determining an incident type for a corresponding incident from a set comprising at least one of a frequent type or a rare type, responsive to an ingested event. The method includes generating, by a machine-learning model, a recommendation for resolving the incident, wherein the machine-learning model is selected based on the determined incident type. The generating includes normalizing incident titles by tokenizing the incident titles and replacing specific types of information with representative tokens, wherein the specific types of information includes timestamps, unique identifiers, and network addresses, executing a collaborative filtering model using the normalized incident titles to identify similar historical incidents, wherein the collaborative filtering model is trained based on features of incidents and features of responders in a historical data set, calculating cosine similarities between the incident and the similar historical incidents, and generating the recommendation based on the cosine similarities, responder availability, the similar historical incidents and a responder skillset. The method includes executing an action determined as a result of the recommendation by an action execution tool, receiving feedback data from the action execution tool indicating an effectiveness of the executed action in resolving the incident, and retraining the machine-learning model using the feedback data.

Other systems, methods, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 shows components of one aspect of a computing environment for event management.

FIG. 2 shows one aspect of a client computer.

FIG. 3 shows one aspect of a network computer that may at least partially implement one of the various aspects.

FIG. 4 illustrates a logical architecture of a system for responder recommendation.

FIG. 5 is a block diagram of an example illustrating the operations of a classifier.

FIG. 6 illustrates examples of templates.

FIG. 7 is a flowchart of an example of a technique for responder recommendations.

FIG. 8 is a flowchart of an example of technique for recommending responders

### DETAILED DESCRIPTION

An event management bus (EMB) is a computer system that may be arranged to monitor, manage, or compare the computer operations of one or more organizations. The EMB may be arranged to accept various events that indicate conditions occurring in computers of the one or more organizations. The EMB may be arranged to manage computers of several separate organizations at the same time.

Briefly, an event can simply be an indication of a state of change to an IT service or component of an organization. An event can be or describe a fact at a moment in time that may consist of a single or a group of correlated conditions that have been monitored and classified into an actionable state. As such, a monitoring tool of an organization may detect a condition in the IT environment of the organization and transmit a corresponding event to the EMB. Depending on the level of impact (e.g., level of degradation of a service), if any, to one or more constituents of a managed organization, an event may trigger (e.g., may be, may be classified as, may be converted into) an incident.

Non-limiting examples of events may include that a monitored operating system process is not executing, that a virtual machine is restarting, that disk space on a certain device is low, that processor utilization on a certain device is higher than a threshold, that a shopping cart service of an e-commerce site is unavailable, that a digital certificate has or is expiring, that a certain web server is returning a 503 error code (indicating that web server is not ready to handle requests), that a customer relationship management (CRM) system is down (e.g., unavailable) such as because it is not responding to ping requests, and so on.

Events may be received by the EMB due to an underlying cause that caused the event to be generated. Additional examples of events (or causes that may have triggered or resulted in the events) include that a particular cloud-based service is down, that a particular database is unresponsive, that a particular product line is exhibiting issue (such as system errors in web applications or web services applications), that a web server is down (resulting in customers being unable to access a website offered by the web server); that a particular database is corrupted (such as due to a hardware failure); that DNS routing in a network is failing (resulting in users not being able to access a website using web browsers).

As can be appreciated, IT systems may include or use many IT components. Such IT components may include, to name a few, open-source or proprietary libraries, open-source or proprietary operating systems, open-source or proprietary database systems, cloud computing services, on-premises computing services, open-source or proprietary software platforms, servers, routers, virtual machine, and so on. The malfunction of any one of the IT components can lead to an operational issue.

An event corresponding to the operational issue may be received at an EMB, which in turn may trigger an alert and an incident. Alerts are often resolved by modifying the functioning (e.g., affecting the configuration or execution) of one or more underlying IT components. An event may be received at an ingestion software of the EMB, accepted by the ingestion software and queued for processing, and then processed. Processing an event can include triggering (e.g., creating, generating, instantiating, etc.) a corresponding alert and a corresponding incident in the EMB. The incident may be assigned to a responder (e.g., a person or a group of persons) who may become responsible for resolving the incident.

The responder may investigate the incident (or, equivalently, the alert that triggered the incident) and (ultimately) perform or cause to be performed actions that resolve the incident. The responder may indicate that the incident has been resolved using an interface (e.g., a graphical user interface) of the EMB. In the process of resolving an incident, the responder may associate data with the incident. The data associated with the incident may include one or more of determined or suspected causes of the incident, determined or desired skills necessary to resolve the incident, other data, or a combination thereof.

Incidents may be assigned to responders according to selection criteria. To illustrate, incidents may be assigned on a round-robin basis to responders of a responder group, based on availability of responders, based on a determination (such as by an automated system, management personnel, etc.) that the responder has the necessary skills and/or experience in the causes of the alert to resolve the incident, other selection criteria, or a combination thereof.

To resolve an event (or, equivalently, an incident), the affected IT component(s) (i.e., the IT component(s) that triggered the event) may need to be identified, the causes of the alert may need to be identified, and appropriate actions that resolve the alert may also need to be identified. However, a responder assigned to an incident may in fact lack the expertise or experience to expeditiously perform at least some of these tasks. The inability to expeditiously perform some of these tasks may result in incidents remaining unresolved for much longer than is desired or acceptable therewith prolonging the mean-time-to-resolution (MTTR) of incidents. Such problems are compounded by the ever-evolving nature of IT infrastructure.

In some situation, a responder may not be able to identify the cause of an incident and may choose an action for execution with the hope that the action will resolve the alert. If the action does not resolve the alert, then the responder may choose another action. This repetitive trial-and-error process may continue until the alert is resolved.

Resolving alerts by trial-and-error can prolong the time to resolution, which may lead to user frustration (i.e., direct or indirect users of the IT component(s)), unavailability of services for longer periods of time, and a waste of responders’ time. Additionally, as the EMB expends resources in causing actions to be executed, resolving alerts by trial-and-error can waste computation and network resources, and may degrade the performance of the EMB for other users, at least with respect to processing other events, alerts, and incidents, and may further degrade the performance the IT components that triggered the events.

Furthermore, the impacted IT components, and depending on the event causes, may themselves expend resources when the time-to-resolution is prolonged. To illustrate, the event may indicate high CPU usage or high memory usage by a server, which continue to be a problem while the incident remains unresolved. Thus, the trial-and-error iterative process can result in user and responder productivity loss in addition to increased resource utilization.

The possibility of degraded performance and increased usage of the computational and network resources may also include substantially increased investment in processing, memory, and storage resources and may also result in increased energy expenditures (needed to operate those increased processing, memory, and storage resources, and for the network transmission of the database commands) and associated emissions that may result from the generation of that energy.

Furthermore, in some configurations of the EMB, the responder assigned to an incident may simply act as a coordinator of other responders who are to resolve the incident or may act as a first level support and may need to identify other responders who may be able to resolve incident or to whom the incident should be transferred. As such, resolving an incident can include identifying other responders for the incident.

To illustrate, a responder assigned to an incident may be a new person to a team, may not have sufficient expertise to resolve a particular incident, or may still be training and/or may need to reassign the incident to the correct team or person. For example, if the pool of responders is unknown or is too large, it can be difficult to find the most relevant responders to call in to help, whether it is the person on the right team, the person with the right set of technical skills to solve the problem or expertise with that system. If the wrong responders are selected, then the incident may end up being transferred from responder to responder therewith extending the time-to-resolution and leading to the above mentioned problems.

To shorten the time-to-resolution of incidents with the minimal amount of compute resource expenditure, a responder assigned to an incident may need to identify other responders, such as other responders who may have expertise with or in resolving similar incidents. More generally, with respect to an incident, responders to be identified may be responders associated with similar incidents or with causes of other incidents that may be the same or similar causes of the incident.

However, existing EMBs lack the technical capabilities to identify, based on an incident, recommended responders that may be helpful in expeditiously resolving incidents. An EMB that implements smart incident responder recommendation, as described herein, facilitates incident resolution in an EMB so that mean-time-to-resolution (MTTR) of incidents can be minimized therewith maximizing uptime(s) of components, systems, devices, services, etc. of an IT environment of a managed organization and results in reduced compute resource expenditure. Recommended responders for responding to incidents are identified based on a historical collection of incidents (such as a database or a training set) used in conjunction with historical incidents and expertise of responders or responder teams involved (e.g., associated) with those historical incidents, and a collection of responders who have responded to those incidents.

Causes of events or incidents may be identified and recommended responders may be identified based on the causes. For example, when an incident is received, similar incidents may be identified, such as based on respective causes of the incident and the identified incidents. At least some of responders associated with the identified incidents may be recommended responders from whom assistance may be solicited for resolving the incident.

The term “event,” as used herein, can refer to one or more outcomes, conditions, or occurrences that may be detected (e.g., observed, identified, noticed, monitored, etc.) by an event management bus. An event management bus (which can also be referred to as an event ingestion and processing system) may be configured to monitor various types of events depending on needs of an industry and/or technology area. For example, information technology services may generate events in response to one or more conditions, such as, computers going offline, memory overutilization, CPU overutilization, storage quotas being met or exceeded, applications failing or otherwise becoming unavailable, networking problems (e.g., latency, excess traffic, unexpected lack of traffic, intrusion attempts, or the like), electrical problems (e.g., power outages, voltage fluctuations, or the like), customer service requests, or the like, or combination thereof.

Events may be provided to the event management bus using one or more messages, emails, telephone calls, library function calls, application programming interface (API) calls, including, any signals provided to an event management bus indicating that an event has occurred. One or more third party and/or external systems may be configured to generate event -8- messages that are provided to the event management bus.

The term “responder” as used herein can refer to a person or entity, represented or identified by persons, that may be responsible for responding to an event associated with a monitored application or service. A responder is responsible for responding to one or more notification events. For example, responders may be members of an information technology (IT) team providing support to employees of a company. Responders may be notified if an event or incident they are responsible for handling at that time is encountered. In some aspects, a scheduler application may be arranged to associate one or more responders with times that they are responsible for handling particular events (.e.g., times when they are on-call to maintain various IT services for a company). A responder that is determined to be responsible for handling a particular event may be referred to as a responsible responder. Responsible responders may be considered to be on-call and/or active during the period of time they are designated by the schedule to be available.

The term “incident” as used herein can refer to a condition or state in the managed networking environments that requires some form of resolution by a user or automated service. Typically, incidents may be a failure or error that occurs in the operation of a managed network and/or computing environment. One or more events may be associated with one or more incidents. However, not all events are associated with incidents.

The term “team” or “group” as used herein refers to one or more responders that may be jointly responsible for maintaining or supporting one or more services or system for an organization. The following briefly describes the aspects of the disclosure in order to provide a basic understanding of some aspects of the disclosure. This brief description is not intended as an extensive overview. It is not intended to identify key or critical elements, or to delineate or otherwise narrow the scope. Its purpose is merely to present some concepts in a simplified form as a prelude to the more detailed description that is presented later

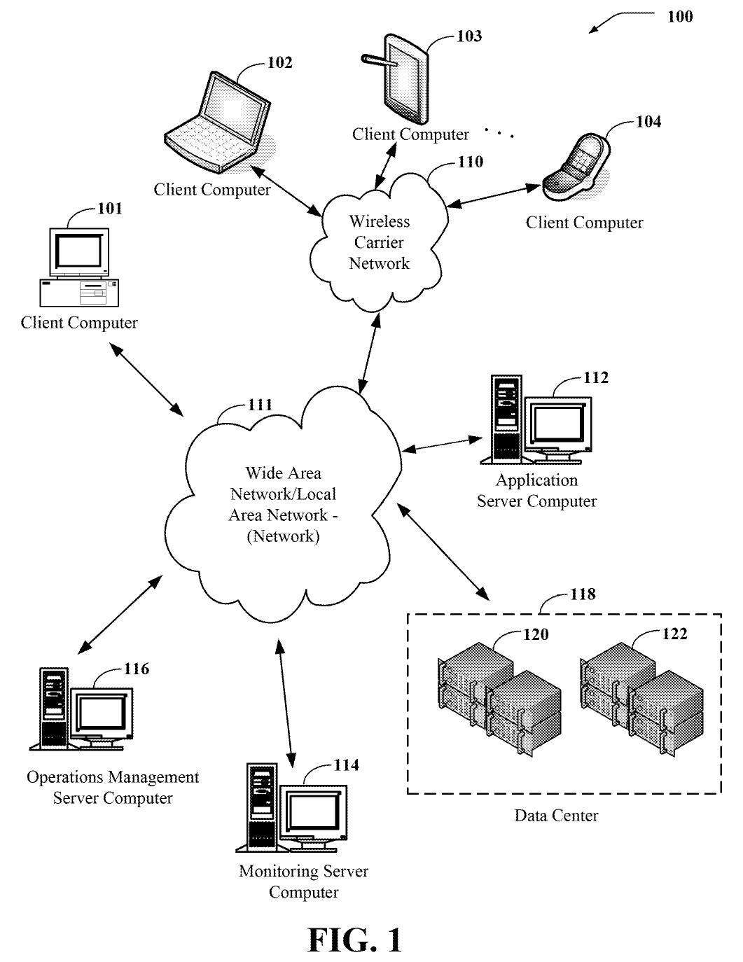

FIG. 1 shows components of one aspect of a computing environment 100 for event management. Not all the components may be required to practice various aspects, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement an EMB.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IOT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one aspect, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one aspect, one or more of the client computers 101-104 may be configured to operate within a business or other entity to perform a variety of services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other aspects. Further, it should be recognized that more or less client computers may be included within a system such as described herein, and aspects are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one aspect, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, or the like, to display and send a message. In one aspect, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. In essence, the wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. In essence, the network 111 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

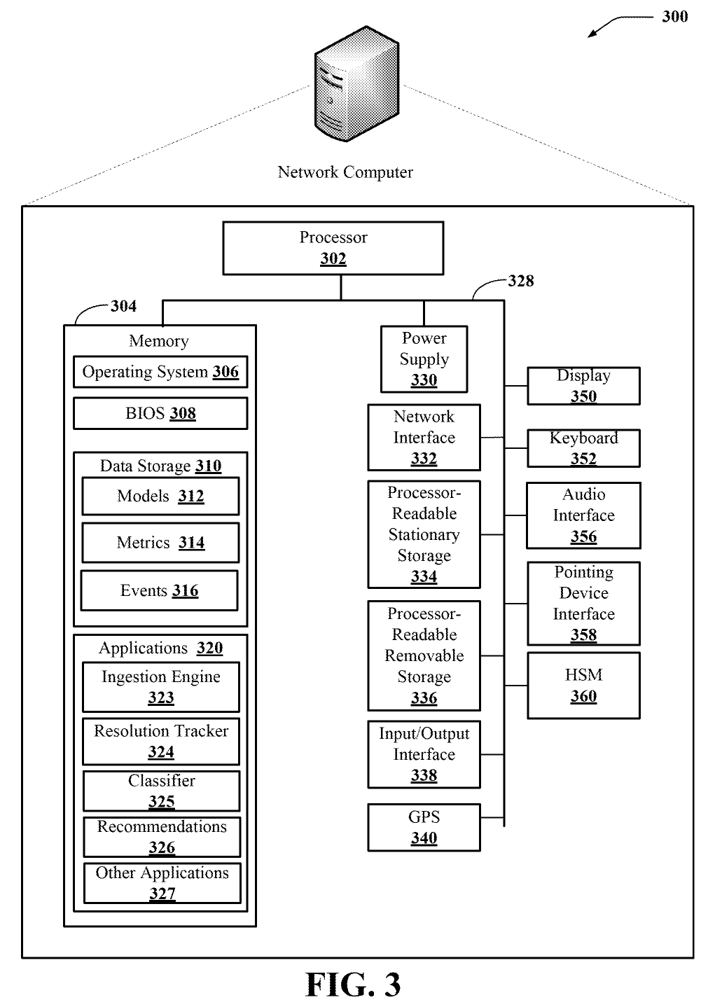

The operations management server computer 116 may include virtually any network computer usable to provide computer operations management services, such as a network computer, as described with respect to FIG. 3. In one aspect, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various aspects, the monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some aspects, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the disclosure is not so limited. Thus, the operations management server computer 116 may represent a plurality of network computers. For example, in one aspect, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some aspects, one or more data centers, such as a data center 118, may be communicatively coupled to the wireless network 110 and/or the network 111. In at least one of the various aspects, the data center 118 may be a portion of a private data center, public data center, public cloud environment, or private cloud environment. In some aspects, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some aspects, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may include multiple physical network computers, interconnected by one or more networks, such as, networks similar to and/or the including network 111 and/or wireless network 110. The data center 118 may enable and/or provide one or more cloud instances (not shown). The number and composition of cloud instances may be vary depending on the demands of individual users, cloud network arrangement, operational loads, performance considerations, application needs, operational policy, or the like. In at least one of the various aspects, the data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

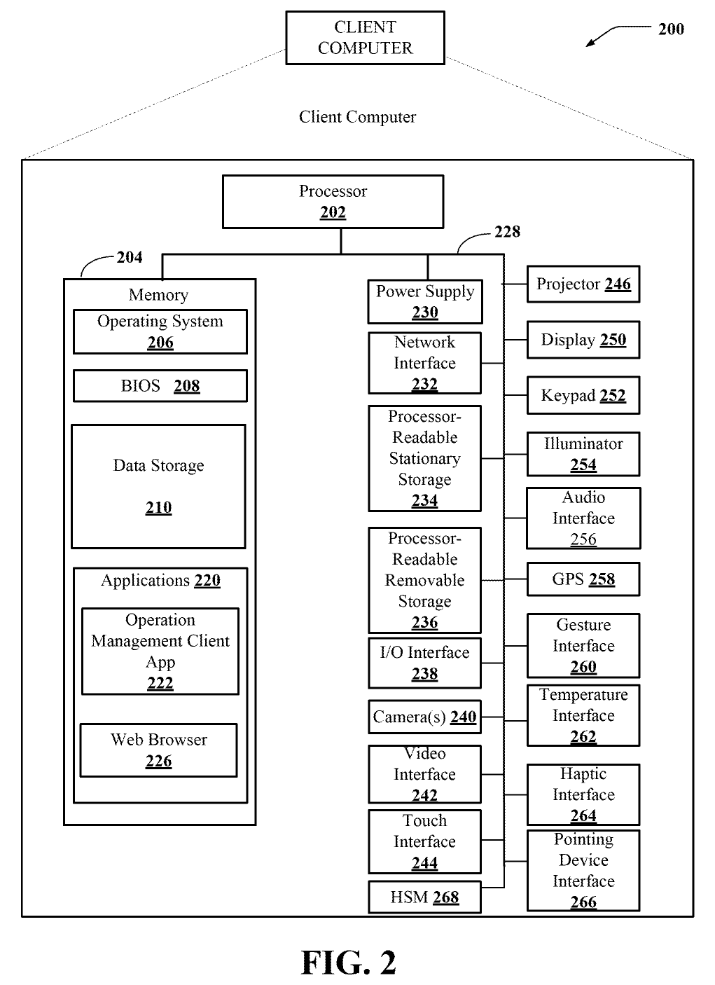

FIG. 2 shows one aspect of a client computer 200. The client computer 200 may include more or less components than those shown in FIG. 2. The client computer 200 may represent, for example, at least one aspect of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) transceiver 258, an open air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one aspect, although not shown, a gyroscope may be employed within the client computer 200 to measuring or maintaining an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some aspects, hardware security module may be employed to support one or more standard public key infrastructures (PKI), and may be employed to generate, manage, or store keys pairs, or the like. In some aspects, the HSM 268 may be a stand-alone computer, in other cases, the HSM 268 may be arranged as a hardware card that may be added to a client computer.

The I/O interface 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open air gesture interface 260 may sense physical gestures of a user of the client computer 200, for example, by using single or stereo video cameras, radar, a gyroscopic sensor inside a computer held or worn by the user, or the like. The camera 240 may be used to track physical eye movements of a user of the client computer 200.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one aspect, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user’s gestures toward portions of an image projected by the pico projector onto a reflected surface such as a wall or the user’s hand.

A client computer may include a web browser application 226 that is configured to receive and to send web pages, web-based messages, graphics, text, multimedia, and the like. The client computer’s browser application may employ virtually any programming language, including a wireless application protocol messages (WAP), and the like. In at least one aspect, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUXTM, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one aspect, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. In at least one of the various aspects, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more aspects (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more aspects (not shown in the figures), the client computer 200 may include a hardware microcontroller instead of a CPU. In at least one aspect, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one aspect of network computer 300 that may at least partially implement one of the various aspects. The network computer 300 may include more or less components than those shown in FIG. 3. The network computer 300 may represent, for example, one aspect of at least one EMB, such as the operations management server computer 116 of FIG. 1, the monitoring server computer 114 of FIG. 1, or an application server computer 112 of FIG. 1. Further, in some aspects, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one aspect, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUXTM, or a specialized operating system such as Microsoft Corporation’s Windows ® operating system, or the Apple Corporation’s IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one aspect, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may include an ingestion engine 323, a resolution tracker engine 324, a classifier 325, a recommendation engine 326 (which may be or include a machine-learning model as further described herein), other applications 327. In at least one of the various aspects, one or more of the applications may be implemented as modules or components of another application. Further, in at least one of the various aspects, applications may be implemented as operating system extensions, modules, plugins, or the like.

Furthermore, in at least one of the various aspects, the ingestion engine 323, the resolution tracker engine 324, the classifier 325, the pre-processing engine 326, the other applications 327, or the like, may be operative in a cloud-based computing environment. In at least one of the various aspects, these applications, and others, that comprise the management platform may be executing within virtual machines or virtual servers that may be managed in a cloud-based based computing environment. In at least one of the various aspects, in this context the applications may flow from one physical network computer within the cloud-based environment to another depending on performance and scaling considerations automatically managed by the cloud computing environment. Likewise, in at least one of the various aspects, virtual machines or virtual servers dedicated to the ingestion engine 323, the resolution tracker engine 324, the classifier 325, the pre-processing engine 326, the other applications 327, may be provisioned and de-commissioned automatically.

In at least one of the various aspects, the applications may be arranged to employ geo-location information to select one or more localization features, such as, time zones, languages, currencies, calendar formatting, or the like. Localization features may be used in user-interfaces and well as internal processes or databases. Further, in some aspects, localization features may include information regarding culturally significant events or customs (e.g., local holidays, political events, or the like) In at least one of the various aspects, geo-location information used for selecting localization information may be provided by the GPS transceiver 340. Also, in some aspects, geolocation information may include information providing using one or more geolocation protocol over the networks, such as, the wireless network 108 or the network 111.

Also, in at least one of the various aspects, the ingestion engine 323, the resolution tracker engine 324, the classifier 325, the pre-processing engine 326, the other applications 327, or the like, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some aspects, hardware security module may be employed to support one or more standard public key infrastructures (PKI), and may be employed to generate, manage, or store keys pairs, or the like. In some aspects, the HSM 360 may be a stand-alone network computer, in other cases, the HSM 360 may be arranged as a hardware card that may be installed in a network computer.

Additionally, in one or more aspects (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more aspects (not shown in the figures), the network computer may include a hardware microcontroller instead of a CPU. In at least one aspect, the microcontroller may directly execute its own embedded logic to perform actions and access its own internal memory and its own external Input and Output Interfaces (e.g., hardware pins or wireless transceivers) to perform actions, such as System On a Chip (SOC), or the like.

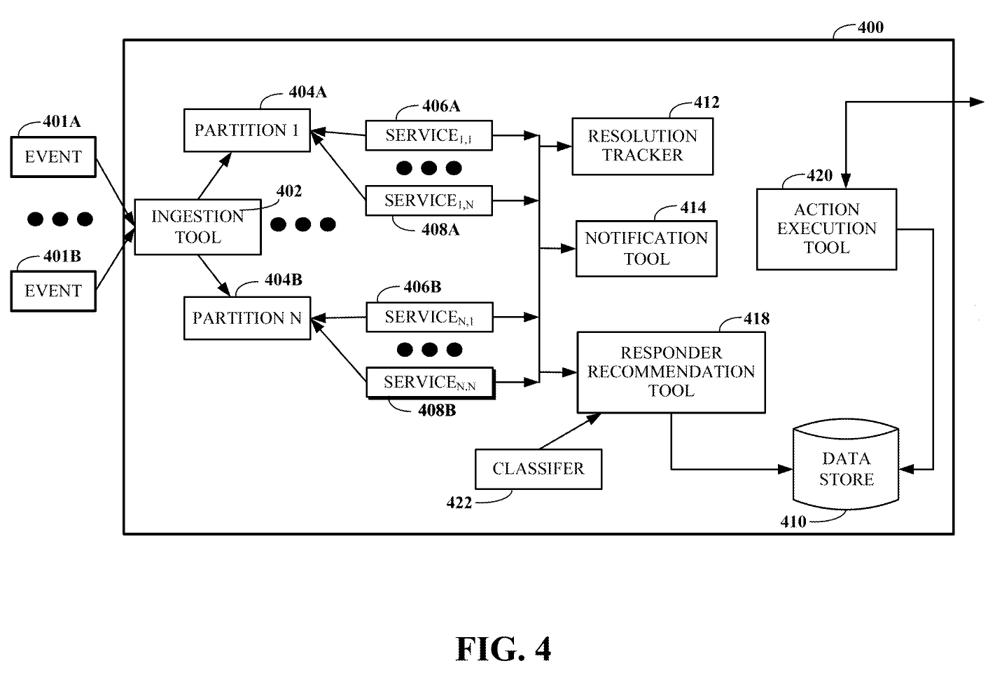

FIG. 4 illustrates a logical architecture of a system 400 for responder recommendation software. The system 400 can be an EMB or a system within or interfaced with an EMB and can be used to generate lists of recommended responders for an incident in a network environment.

In an example, an incident may trigger an alert responsive to an event in a network managed system. The system 400 uses data associated with the incident (including data associated with objects related to the incident, such as an alert) to obtain a type (i.e., an incident type) for the incident. The data associated with the incident can include an attribute or a combination of attributes, descriptive data, payload data, or other data. For example, a title of the incident can be used to obtain the incident type. For example, an incident type may be associated with an incident based on metadata of an event that triggered an alert, which in turn triggered the incident. The system 400 uses the incident type to identify recommended responders.

In at least one of the various embodiments, a system for responder recommendations may include various components. In this example, the system 400 includes an ingestion tool 402, one or more partitions 404A-404B, one or more services 406A-406B and 408A-408B, a data store 410, a resolution tracker 412, a notification tool 414, a responder recommendation tool 418, and an action execution tool 420.

One or more systems, such as monitoring systems, of one or more organizations may be configured to transmit events to the system 400 for processing. The system 400 may provide several services. A service may, for example, process an event into an actionable item (e.g., an alert). As mentioned above, a received event may trigger an alert, which may trigger an incident, which in turn may cause notifications to be transmitted to responders.

A received event from an organization may include an indication of one or more services that are to operate on (e.g., process, etc.) the event. The indication of the service may be referred to as a routing key. A routing key may be unique to a managed organization. As such, two events that are received from two different managed organizations for processing by a same service would include two different routing keys. A routing key may be unique to the service that is to receive and process an event. As such, two events associated with two different routing keys and received from the same managed organization for processing may be directed to (e.g., processed by) different services.

The ingestion tool 402 may be configured to receive or obtain one or more different types of events provided by various sources, here represented by events 401A, 401B. The ingestion tool 402 may accept or reject received events. In an example, events may be rejected when events are received at a rate that is higher than a configured event acceptance rate. If the ingestion tool 402 accepts an event, the ingestion tool 402 may place the event in a partition for further processing. If an event is rejected, the event is not placed in a partition for further processing. The ingestion software may notify the sender of the event of whether the event was accepted or rejected. Grouping events into partitions can be used to enable parallel processing and/or scaling of the system 400 so that the system 400 can handle (e.g., process, etc.) more and more events and/or more and more organizations.

The ingestion tool 402 may be arranged to receive the various events and perform various actions, including, filtering, reformatting, information extraction, data normalizing, or the like, or combination thereof, to enable the events to be stored (e.g., queued, etc.) and further processed. In at least one of the various embodiments, the ingestion tool 402 may be arranged to normalize incoming events into a unified common event format. Accordingly, in some embodiments, the ingestion tool 402 may be arranged to employ configuration information, including, rules, templates, maps, dictionaries, or the like, or combination thereof, to normalize the fields and values of incoming events to the common event format. The ingestion tool 402 may assign (e.g., associate, etc.) an ingested timestamp with an accepted event.

In at least one of the various embodiments, an event may be stored in a partition, such as one of the partition 404A or the partition 404B. A partition can be, or can be thought of, as a queue (i.e., a first-in-first-out queue) of events. FIG. 4 is shown as including two partitions (i.e., the partitions 404A and 404B). However, the disclosure is not so limited and the system 400 can include one or more than two partitions.

In an example, different services of the system 400 may be configured to operate on events of the different partitions. In an example, the same services (e.g., identical logic) may be configured to operate on the accepted events in different partitions. To illustrate, in FIG. 4, the services 406A and 408A process the events of the partition 404A, and the services 406B and 408B process the events of partition the 404B, where the service 406A and the service 406B execute the same logic (e.g., perform the same operations) of a first service but on different physical or virtual servers; and the service 408A and the service 408B execute the same logic of a second service but on different physical or virtual servers. In an example, different types of events may be routed to different partitions. As such, each of the services 406A-406-B and 408A-408B may perform different logic as appropriate for the events processed by the service.

An (e.g., each) event, may also be associated with one or more services that may be responsible for processing the events. As such, an event can be said to be addressed or targeted to the one or more services that are to process the event. As mentioned above, an event can include or can be associated with a routing key that indicates the one or more services that are to receive the event for processing.

Events may be variously formatted messages that reflect the occurrence of events or incidents that have occurred in the computing systems or infrastructures of one or more managed organizations. Such events may include facts regarding system errors, warning, failure reports, customer service requests, status messages, or the like. One or more external services, at least some of which may be monitoring services, may collect events and provide the events to the system 400. Events as described above may be comprised of, or transmitted to the system 400 via, SMS messages, HTTP requests/posts, API calls, log file entries, trouble tickets, emails, or the like. An event may include associated information, such as, source, a creation time stamp, a status indicator, more information, fewer information, other information, or a combination thereof, that may be tracked.

In at least one of the various embodiments, the data store 410 may be arranged to store performance metrics, configuration information, or the like, for the system 400. In an example, the data store 410 may be implemented as one or more relational database management systems, one or more object databases, one or more XML databases, one or more operating system files, one or more unstructured data databases, one or more synchronous or asynchronous event or data buses that may use stream processing, one or more other suitable non-transient storage mechanisms, or a combination thereof.

Data related to events, alerts, incidents, notifications, other types of objects, or a combination thereof may be stored in the data store 410. The data store 410 can include data related to resolved and unresolved alerts. The data store 410 can include data identifying whether alerts are or not acknowledged.

With respect to a resolved alert, the data store 410 can include information regarding the resolving entity that resolved the alert (and/or, equivalently, the resolving entity of the event that triggered the alert), the duration that the alert was active until it was resolved, other information, or a combination thereof. The resolving entity can be a responder (e.g., a human). The resolving entity can be an integration (e.g., automated system), which can indicate that the alert was auto resolved. That the alert is auto resolved can mean that the system 400 received, such as from the integration, an event indicating that a previous event, which triggered the alert, is resolved. The integration may be a monitoring system.

The data store 410 can include data related to actions performed with respect to alerts. The data store 410 can include data indicating whether an action cleared (or contributed to clearing) a triggering event, or equivalently, the event. The data store 410 can also include associations (i.e., action-component associations) between actions and IT components and associations (i.e., alert-to-component associations) between alerts (i.e., alert types) and IT components.

The data store 410 can include data identifying responders associated with incidents. That a responder is associated with an incident can include that the responder may have participated in or was a member of a team that ultimately resolved an incident or currently investigating a pending incident. The data store 410 can include data identifying skills associated with responders (collectively, respective skillsets of responders). With respect to an incident, the data store 410 can include indicating when various responders, if any, were associated with the incident. That a responder is associated with an incident can mean that the responder was added to the incident so that the responder can resolve or can help in resolving, can identify or can help in identifying causes of the incident or actions that might resolve the incident.

In at least one of the various embodiments, the resolution tracker 412 may be arranged to monitor details regarding how events, alerts, incidents, other objects received, created, managed by the system 400, or a combination thereof are resolved. In some embodiments, this may include tracking incident and/or alert life-cycle metrics related to the events (e.g., creation time, acknowledgement time(s), resolution time, processing time,), the resources that are/were responsible for resolving the events, the resources (e.g., the responder or the automated process) that resolved alerts, and so on.

The resolution tracker 412 can receive data from the different services that process events, alerts, or incidents. Receiving data from a service by the resolution tracker 412 encompasses receiving data directly from the service and/or accessing (e.g., polling for, querying for, asynchronously being notified of, etc.) data generated (e.g., set, assigned, calculated by, stored, etc.) by the service. The resolution tracker can receive (e.g., query for, read, etc.) data from the data store 410. The resolution tracker can write (e.g., update, etc.) data in the data store 410. The resolution tracker 412 can receive, and store in the data store 410, feedback data regarding whether actions performed with respect to alerts resolved or did not resolve the alerts.

While FIG. 4 is shown as including one resolution tracker 412, the disclosure herein is not so limited and the system 400 can include more than one resolution tracker. In an example, different resolution trackers may be configured to receive data from services of one or more partitions. In an example, each partition may have associated with one resolution tracker. Other configurations or mappings between partitions, services, and resolution trackers are possible.

The notification tool 414 may be arranged to generate notification messages for at least some of the accepted events. The notification messages may be transmitted to responders (e.g., responsible users, teams) or automated systems. The notification tool 414 may select a messaging provider that may be used to deliver a notification message to the responsible resource. The notification tool 414 may determine which resource is responsible for handling the event message and may generate one or more notification messages and determine particular message providers to use to send the notification message.

In at least one of the various embodiments, a scheduler (not shown) may determine which responder is responsible for handling an incident based on at least an on-call schedule and/or the content of the incident. The notification tool 414 may generate one or more notification messages and determine a particular message providers to use to send the notification message. Accordingly, the selected message providers may transmit (e.g., communicate, etc.) the notification message to the responder. Transmitting a notification to a responder, as used herein, and unless the context indicates otherwise, encompasses transmitting the notification to a team or a group. In some embodiments, the message providers may generate an acknowledgment message that may be provided to system 400 indicating a delivery status of the notification message (e.g., successful or failed delivery).

In at least one of the various embodiments, the notification tool 414 may determine the message provider based on a variety of considerations, such as, geography, reliability, quality-of-service, user/customer preference, type of notification message (e.g., SMS or Push Notification, or the like), cost of delivery, or the like, or combination thereof. In at least one of the various embodiments, various performance characteristics of each message provider may be stored and/or associated with a corresponding provider performance profile. Provider performance profiles may be arranged to represent the various metrics that may be measured for a provider. Also, provider profiles may include preference values and/or weight values that may be configured rather than measured.

In at least one of the various embodiments, the responder recommendation tool 418 identifies recommended responders that may be presented to a responder for resolving an incident. The responder recommendation tool 418 is or includes one or more machine-learning models for recommending responders to incidents. Thus, the responder recommendation tool 418 may also be referred to as a machine-learning model recommendation engine.

The recommended responders can be presented to the responder in a user interface of (e.g., generated by) the system 400. In response to a selection of one or more of the recommended responders, the responder recommendation tool 418 associates the selected recommended responders with the incident, which may cause notifications to be transmitted to the selected recommended responders.

The responder recommendation tool 418 uses a historical collection of incidents stored in the data store 410, causes associated with the incidents, skills identified as required for (or at least helpful in) resolving the incidents. Each of the incidents in the data store 410 may be associated with a respective type. Such data are paired with a historical collection of responders who have previously (e.g., in the past) responded to the incidents (e.g., responded to incidents having certain types). Given an incident as input, the responder recommendation tool 418 outputs recommend responders or teams or responders that may be called upon (such as by associating one or more of the recommend responders with the incident) by the assigned responder to at least assist in resolving the incident.

The responder recommendation tool 418 can be regularly retrained using additional data (which are described above) so that improved responder recommendations are obtained. Refining the responder recommendations includes that, over time, and as more responders are associated with successful resolution of incidents, the system 400 learns to provide more accurate responder recommendations.

The responder recommendation tool 418 may use different techniques or learning models for identifying recommended responders based on a type identified for a received incident. For example, if the incident is determined to be of a frequent type, then a collaborative-filtering learning model may be used; if the incident is determined to be of a rare type, then a content-based filtering learning model may be used; if the incident is determined to be of a novel type (e.g., a similar incident has not been previously processed by the system 400), then the responder recommendation tool 418 may recommend responders based on their respective seniority levels.

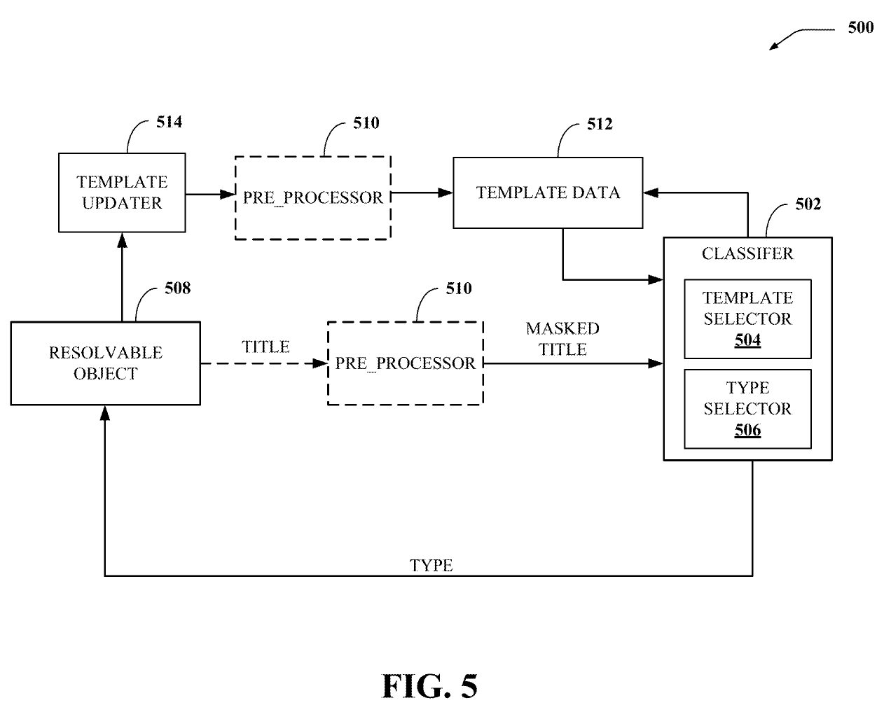

The responder recommendation tool 418 may include or may work in conjunction with a classifier 422 that can determine incident types. That is, the classifier 422 may receive an incident and output a type for the incident. The classifier 422 is further described with respect to FIG. 5.

The seniority level of a responder, as used herein, refers to a level of expertise, as compared to other responders, estimated for a responder. The seniority of a responder can be estimated based on (e.g., as a function of) a total number of incidents that the responder has been associated with, time-to-resolution of those incidents from the respective times that the responder was associated with the incidents, respective total numbers of responders associated with those incidents, a number of incident types that the responder has been associated with, the number of different causes that the responder has been associated with, fewer criteria, more criteria, or a combination thereof. With respect to the total number of responders associated with incidents, the higher the number of responders associated with an incident, the less of an impact a particular responder is likely to have in resolving the incident.

In at least one of the various embodiments, the system 400 may include various user-interfaces or configuration information (not shown) that enable organizations to establish how events should be resolved. Accordingly, an organization may define, rules, conditions, priority levels, notification rules, escalation rules, routing keys, or the like, or combination thereof, that may be associated with different types of events. For example, some events may be informational rather than associated with a critical failure. Accordingly, an organization may establish different rules or other handling mechanics for the different types of events. For example, in some embodiments, critical events may require immediate (e.g., within the target lag time) notification of a response user to resolve the underlying cause of the event. In other cases, the events may simply be recorded for future analysis. For example, an organization may configure one or more services to auto-pause incident notifications (or, equivalently, to auto-pause alerts).

The action execution tool 420 may receive actions selected by a responder. The action execution tool 420 may include facilities (e.g., tools, software, utilities, or the like) for transmitting the actions to, or causing the actions to be carried out by, IT components in the managed environments. For at least some of the actions, the IT components in the managed environments may return data (e.g., feedback data) to the action execution tool 420 indicating whether the actions were successful or other status data. That data is returned to the action execution tool 420 includes that the data are received by the resolution tracker 412, which stores the data in the data store 410, and those data used (e.g., retrieved) by the action execution tool 420 from the data store 410. The action execution tool 420 may store such status data in the data store 410. For example, the action execution tool 420 may store status data in association with corresponding actions and the alerts for which the actions were performed. Such associations may be used by learning algorithms of the responder recommendation tool 418.

FIG. 5 is a block diagram of an example 500 illustrating the operations of a classifier 502. The example 500 may be implemented in the system 400 of FIG. 4. The classifier 502 can be, can be included in, or can be implemented by, the classifier 422 of FIG. 4. The classifier 502 includes a template selector 504 and a type selector 506. The classifier 502 can be used to obtain types for incidents. The type of an incident may be obtained from a resolvable object, which may be an object related to the incident or the incident itself, as described below.

The description of FIG. 5 uses the term “resolvable object.” A resolvable object can be a construct of the EMB with which a reason for and/or a cause of can be determined, and/or a resolution thereto can be marked. No particular semantics are intended to be attached to the term “object” in “resolvable object.” A resolvable object can be any entity of the EMB that may be associated with a class (such as in the case of object-oriented programming), a data structure that may include metadata (e.g. attributes, fields, etc.), a set of data elements (elementary or otherwise) that can collectively represent a resolvable object, and so on.

A resolvable object can be an object of (e.g., triggered in, created in, received by, etc.) the EMB, or an object related thereto, about which a notification may be transmitted to a responder, with respect to which a responder may directly or indirectly enter an acknowledgement, with respect to which a responder may directly or indirectly enter or indicate a resolution, based on which a responder may perform an action, or a combination thereof. Examples of resolvable objects can include events, incidents, and alerts.

Using templates (e.g., alert templates, incident templates, or event templates), resolvable objects can be identified (e.g., classified, etc.) as being of a particular type. In an example, the incident types can include the rare type, the novel type, the frequent type, or some other types. A resolvable object (e.g. an incident or an alert) can be identified as matching a template based on metadata (e.g., a title, a group of attributes, etc.) of the resolvable object. As further described below, a template can be a set of tokens where some of the tokens are constant parts and other tokens are variable (or placeholder) parts.

An incident may be classified as a frequent incident if the incident (or more generally, the resolvable object) is determined to happen (e.g., occur, be triggered) often and, hence, the data store 410 of FIG. 4 may include sufficient data regarding responders to such an incident. That the data store 410 includes sufficient data regarding frequent incidents can mean that the data store 410 of FIG. 4 includes a number of incidents that meet a frequency criterion. In an example, the frequency criterion can be that the data store includes at least a predefined number of resolved incidents that are similar to the incident. However, other frequency criteria are possible.

An incident may be classified as a rare incident if the data store 410 includes only a limited number of such incidents and, as such, only a limited number of responders (e.g., the same responder) is detected for (e.g., is associated with) the incidents. That the data store 410 includes limited data regarding rare incidents can mean that the data store 410 of FIG. 4 includes a number of incidents that meet a rarity criterion. In an example, the rarity criterion can be that the data store includes no more than a predefined number of resolved incidents that are similar to the incident. However, other rarity criteria are possible.

An incident may be classified as novel if the data store 410 includes no responder data related to the incident or that the data store includes no resolved incidents that are similar to the incident. In this case, the data store 410 of the incident data therein can be said to meet a novelty criterion.

While the teachings herein are mostly described with respect to classifying an incident (an event, an alert, an incident) as rare, novel, or frequent, the disclosure is not so limited. The teachings herein can be used to classify any datum into one or more categories (e.g., incident types) by matching one or more attributes associated with (e.g., of, related to, obtained for, derived from related entities to, etc.) the datum to an incident type and using historical data to determine a number of occurrences of the incident in the historical data wherein at least some of the historical data are associated with respective incidents.

Given a resolvable object (such as in response to an incident being triggered), a template associated with the resolvable object can be identified. The template can be used to identify, such as in a lookback time range, a number of times the same template occurred in the given lookback period before the resolvable object occurred (e.g., before the incident or alert was triggered). The number of occurrences can be used to classify the resolvable object as being of the rare type, the novel type, the frequent type, or some other type.

The classifier 502 receives a masked title, which may be a masked title of a resolvable object 408, and outputs a type (e.g., a classification). The masked title can be obtained from (e.g., generated by, etc.) a pre-processor 510, which can receive the resolvable object 508 or the title of the resolvable title and outputs the masked title. The masked title can be associated with the resolvable object 508. In some examples, the title may not be pre-processed and the classifier 502 can classify the resolvable object 508 based on the title (instead of based on the masked title). In an example, the pre-processor 510 can be part of, or included in, the classifier 502. As such, the classifier 502 can receive the resolvable object 508 (of a title therefor), pre-process the title to obtain the masked title and then obtain a type based on the masked title.

Each resolvable object can have an associated title. The title of the resolvable object 508 may be or may be derived from another object that may be associated with or related to the resolvable object 508. As further described below, the classifier 502 uses historical data of observable objects to obtain (e.g., determine, choose, infer, identify, output, derive, etc.) a type for the resolvable object 508. While the description herein may use an attribute of a resolvable object that may be named “title” and refers to a “masked title,” the disclosure is not so limited. Broadly, a title can be any attribute, a combination of attributes, or the like that may be associated with a resolvable object and from which a corresponding masked string can be obtained.

For brevity, that the classifier 502 receives the resolvable object 508 encompasses at least one or a combination of the following scenarios. That the classifier 502 receives the resolvable object 508 can mean, in an implementation, that the classifier 502 receives the resolvable object 508 itself. That the classifier 502 receives the resolvable object 508 can mean, in an implementation, that the classifier 502 receives a masked title of the resolvable object. That the classifier 502 receives the resolvable object 508 can mean, in an implementation, that the classifier 502 receives the title of the resolvable object. That the classifier 502 receives the resolvable object 508 can mean, in an implementation, that the classifier 502 receives a title or a masked title of an object related to the resolvable object.

The pre-processor 510 may apply any number of text processing (e.g., manipulation) rules to the title of the resolvable object 508 to obtain the masked title. It is noted that the title is not itself changed as a result of the text processing rules. As such, stating that a rule X is applied to the title (such as the title of the resolvable object), or any such similar statements, should be understood to mean that the rule X is applied to a copy of the title. The text processing rules are intended to remove sub-strings that should be ignored when generating templates, which is further described below. For effective template generation (e.g., to obtain optimal templates from titles), it may be preferable to use readable strings (e.g., strings that include words) as inputs to the template generation algorithm. However, titles may not only include readable words. Titles may also include symbols, numbers, or letters. As such, before processing a title through any template generation or template identifying algorithm, the title can be masked to remove some substrings, such as symbols or numbers, to obtain an interpretable string (e.g., a string that is semantically meaningful to a human reader).

To illustrate, and without limitations, assume that a first title resolvable object has a first title “CRITICAL – ticket 310846 issued” and a second resolvable object has a second title “CRITICAL – ticket 310849 issued.” The first and the second titles do not match without further text processing. However, as further described herein, the first and the second titles may be normalized to the same masked title “CRITICAL – ticket <NUMBER> issued.” As such, for purposes of outlier detection using templates, the first resolvable object and the second resolvable object can be considered to be similar or equivalent.

A set of text processing rules may be applied to a title to obtain a masked title. In some implementations, more, fewer, other rules than those described herein, or a combination thereof may be applied. The rules may be applied in a predefined order.

A first rule may be used to replace numeric substrings, such as those that represent object identifiers, with a placeholder. For example, given the title “This is ticket 310846 from Technical Support,” the first rule can provide the masked title “This is ticket <NUMBER> from Technical Support,” where the numeric substring “310846” is replaced with the placeholder “<NUMBER>.” A second rule may be used to replace substrings identified as measurements with another placeholder. For example, given the title “Disk is 95% full in lt-usw2-dataspeedway on host:lt-usw2-dataspeedway-dskafka-03,” the second rule can provide the masked title “Disk is <MEASUREMENT> full in lt-usw2-dataspeedway on host:lt-usw2-dataspeedway-dskafka-03,” where the substring “95%” is replaced with the placeholder “<MEASUREMENT>”.

The text processing rules may be implemented in any number of ways. For example, each of the rules may be implemented as a respective set of computer executable instructions (e.g., a program, etc.) that carries out the function of the rule. At least some of the rules may be implemented using pattern matching and substitution, such as using regular expression matching and substitution. Other implementations are possible.

The classifier 502 uses a template data 512, which can include templates used for matching. The template selector 504 of the classifier 502 identifies a template of the template data 512 that matches the resolvable object 508 (or a title or a matched title, as the case may be, depending on the input to the classifier 502).

The type selector 506 obtains a classification (i.e., a type) for the resolvable object based on the identified template. The type selector 506 uses historical data and the identified template to obtain the type. As mentioned above, the type selector 506 can obtain the type according to one or more configurations. As such, for example, responsive to historical data meeting a first condition, the type selector can determine (e.g., identify, select, choose, obtain, etc.) that the resolvable object 508 is of the rare type; responsive to the historical data meeting a second condition, the type selector can determine that the resolvable object 508 is of the novel type; and responsive to the historical data meeting a third condition, the type selector can determine that the resolvable object 508 is of the frequent type.

To illustrate, and without limitations, if a template matching the title of an incident occurs more than 20% of the times in the last 30 days of the historical incident data of a service, then the incident is classified as being of the frequent type. Said another way, if at least 20% of titles of the last 30 days of incidents match the same template, then any incidents matching the template are classified as frequent incidents. As another illustration, if a template identified for an incident occurs less than 5% but more than 0% in the last 30 days in the historical incident data of a service, then the incident is of the rare type. In yet another illustration, if the template associated with an incident has not occurred in the last 30 days, then the incident is classified as novel.

A template updater 514 can be used to update the template data 512. The template data 512 can be updated according to update criteria. In an example, resolvable objects received within a recent time window can be used to update the template data 512. In an example, the recent time window can be 10 seconds, 15 seconds, 1 minute, or some other recent time window. In an example, the template data 512 is updated after at least a certain number of new resolvable objects are created in the system 400 of FIG. 4. Other update criteria are possible. For example, the template data of different routing keys or of different managed organizations can be updated according to different update criteria.

In an example, the template updater 514 can be part of the template selector 504. As such, in the process of identifying templates for resolvable objects received within the recent time window, new templates may be added to the template data 512. Said another way, in the process of identifying a type of a resolvable object (based on the title or the masked title, as the case may be), if a matching template is identified, that template is used; otherwise, a new template may be added to the template data 512.

In an example, incident (or alert) titles may be normalized to obtain normalized titles. The normalized titles can be tokenized, cleaned, and vectorized. Tokenizing can split the normalized title into words and/or groups of groups (collectively, n-grams), typically using special characters and/or white spaces to identify the n-grams. Cleaning (e.g., normalizing) the words of the normalized title, which may be performed before or after the tokenizing, can include zero or more of stemming, removing stop words (e.g., very common, words that do not add value to the title) from the word vector, other steps, or a combination thereof. Vectorizing can mean converting the n-grams into respective vector representations of numbers based on all the words identified in the training dataset (i.e., all words of the normalized titles used for training the ML model). Any number of techniques can be used to vectorize the word vector, such as count vectorization, n-gram selection, term frequency–inverse document frequency (TFIDF), or other techniques.

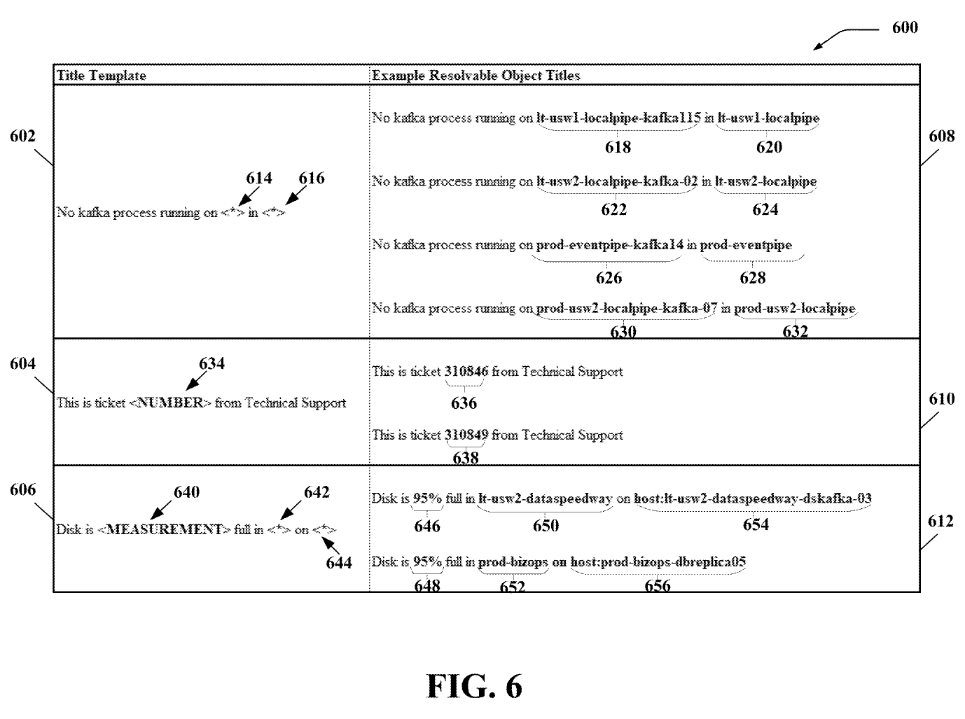

FIG. 6 illustrates examples 600 of templates. Templates can be obtained from titles or masked titles, as the case may be. FIG. 6 illustrates three templates; namely templates 602-606. The templates 602, 604, 606 may be derived from (i.e., at template update time) or may match (i.e., at classification time) the title groups 608, 610, 612, respectively.

As mentioned above, templates include constant parts and variable parts. The constant parts of a template can be thought of as defining or describing, collectively, a distinct state, condition, operation, failure, or some other distinct semantic meaning as compared to the constant parts of other templates. The variable parts can be thought of as defining or capturing a dynamic, or variable state to which the constant parts apply.

To illustrate, the template 602 includes, in order of appearance in the template, the constant parts “No,” “kafka,” “process,” “running,” and “in;” and includes variable parts 614 and 616 (represented by the pattern <*> to indicate substitution patterns). The variable part 614 can match or can be derived from substrings 618, 622, 626, and 630 of the title group 608; and the variable part 616 can match or can be derived from substrings 620, 624, 628, and 632 of the title group 608. The template 604 does not include variable parts. However, the template 604 includes a placeholder 634, which is identified from or matches a mask of numeric substrings 636 and 638, as described above. The template 606 includes a placeholder 640 and variable parts 642, 644. The placeholder 640 can result from or match masked portions 646 and 648. The variable part 642 can match or can be derived from substrings 650 and 652. The variable part 644 can match or can be derived from substrings 654 and 656.

In obtaining templates from titles or masked titles, as the case may be, such as by the template updater 514, it is desirable that the templates include a balance of constant and variable parts. If a template includes too many constant parts as compared to the variable parts, then the template may be too specific and would not be usable to combine similar titles together into a group or cluster for the purpose of classification. Such a template can result in false negatives (i.e., unmatched titles that should in fact be identified as similar to other titles). If a template includes too many variable parts as compared to the constant parts, then the template can practically match titles even though they are not in fact similar. Such templates can result in many false positive matches.

To illustrate, given the title “vednssoa04.atlqa1/keepalive : No keepalive sent from client for 2374 seconds (>=120),” a first algorithm may obtain a first template “vednssoa04.atlis1/keepalive : No keepalive sent from client for <*> seconds <*>,” a second algorithm may obtain a second template “<*> : <*> <*> <*> <*> client <*> <*> <*> <*>,” and a third algorithm may obtain a third template “<*> : No keepalive sent from client for <*> seconds <*>.” The first template capturers (includes) very few parameters as compared to the constant parts. The second template includes too many parameters. The third template includes a balance of constant and variable parts.

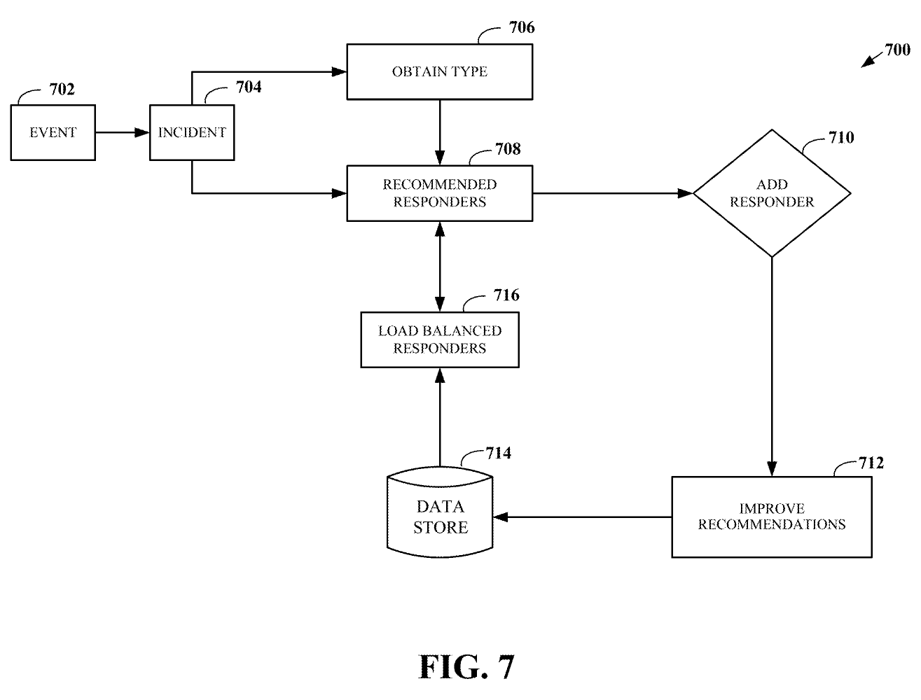

FIG. 7 is a flowchart of an example of a technique 700 for responder recommendations. The technique 700 can be implemented in or by an EMB, such as the system 400 of FIG. 4. The technique 700 may be implemented in whole or in part by a responder recommendation software or a machine-learning model recommendation engine, such as the responder recommendation tool 418 of FIG. 4, a classifier, such as the classifier 422 of FIG. 4. The technique 700 can be implemented, for example, as a software program that may be executed by computing devices such as the network computer 300 of FIG. 3. The software program can include machine-readable instructions that may be stored in a memory (e.g., a non-transitory computer readable medium), such as the memory 304, the processor-readable stationary storage device 334, or the processor-readable removable storage device 336 of FIG. 3, and that, when executed by a processor, such as the processor 302 of FIG. 3, may cause the computing device to perform the technique 700. The technique 700 can be implemented using specialized hardware or firmware. Multiple processors, memories, or both, may be used.

The technique 700 may generate, using one or more machine-learning models, a list of recommended responders based an incident type of an incident, a historical frequency of the incident (based on the incident type), the respective skillsets of responders available to address the incident, other data, or a combination thereof. The technique 700 may analyze processed data such as templatized or “tokenized” incident data parsed from the received incident; determine a history of responders associated with the incident type or similar incidents; analyze, if available, data on what knowledge is necessary to respond to the incident; if available, data on what skills responders have based on a profile of a responder in the recommendation engine. The responder recommendation tool may recommend a list of responders or teams qualified (e.g., predicted or determined to be at least sufficiently qualified) to respond to the incident.

At 702, an event is received. At 704, an incident is triggered from the event. At 706, a type is obtained for the incident (or event or alert). The type may be obtained using a classifier, such as the classifier 422 of FIG. 4 or the classifier 502 of FIG. 5. In one aspect, the responder recommendation tool may determine the incident type for the incident by, responsive to incident data meeting a first condition (i.e., a rarity criterion), determining that the incident is of the rare type. The technique 700 may, responsive to the incident data meeting a second condition (i.e., a novelty criterion), determine that the incident is of the novel type; and responsive to the incident data meeting a third condition (i.e., a frequency criterion), determine that the incident is of the frequent type.

At 708, a list of recommended responders is obtained. The list of recommended responders can be obtained based at least in part on the type of the incident, as described herein. The list of recommended responders may be a ranked list of responders. The list may be ranked based on respective scores output by the machine-learning model used to generate the list of recommended responders. In the case of a novel incident, the responders may be ranked based on respective seniority scores of the recommended responders.

As described with respect to FIG. 5, an incident title may be fuzzed. Fuzzing an incident title can mean tokenizing the incident tile to obtain a set of tokens and using the tokens to identify similar incidents (i.e., similar incident titles). As mentioned above, collaborative filtering may be used in the case of the frequent type; content-based filtering may be used in the case of the rare type; and responder seniority can be used in the case of the novel type.

Collaborative filtering and content-based filtering are techniques that the technique 700 can use to provide responder recommendation. With respect to incidents that have never happened before (i.e., novel incidents), a cold start data problem exists and a seniority-based responder profile is used to recommend responders. The cold start data problem means that no historical data is available for training a recommendation model.

In the case of collaborative filtering, features of the similar incidents and features of responders can be combined to obtain the list of recommended responders. More specifically, features of incidents and features of responders in a historical data set (i.e., a training set) can be used to train a collaborative filtering mode to, given an incident as an input, output a list of recommended responders. That is, similarities between features of incidents and similarities between features of responders can be simultaneously used, by the collaborative filtering model, to obtain the recommended responders. That an incident is used as an input to the model can include that the title of the incident, that a template associated with the incident, or that the tokens obtained from the incident can be used as inputs to the model. While not specifically described herein, and as a person skilled in the art recognizes, at least some of the incident features and responder features may be represented as vectors of numbers, which may also be referred to as embeddings.

The features of incidents can include the tokens associated with the incidents, the skills associated with the incidents (e.g., skills identified as being required or helpful in resolving the incidents), the causes associated with the incidents (e.g., the causes identified as being the reasons for the incidents), the responders associated with the incidents, time to resolution from respective times that responders were associated with the incidents, fewer features, more features, other features, or a combination thereof.

With respect to incident causes, in some cases (i.e., for some incidents), the received alerts may include at least some of cause data. As such, incident causes can be extracted therefrom. Cause data may also obtained from (or provide by) responders assigned to incidents. For example, as an incident is investigated or after it has been resolved, responders associated with the incident may add cause data to the incident.

In an example, incident features can include resolution data, which can be data relating to how incidents were resolved. As mentioned above, an incident may be resolved by a human performing some actions or by an automated tools (scripts, a set of executable steps, etc.). In the case that an incident was resolved by human actions, a responder associated with the incident may associate resolution data (e.g., actions performed). In the case that an incident was resolved automatically, the resolution data can be or include the automated tools executed to resolve the incident.

The features associated with the responders can include the skills associated with the responders, the causes associated with incidents that the responders are in turn associated with, other features, or a combination thereof. As such, for example, a responder may be recommended for resolving an incident based on similarities between the recommended responder and other responders in conjunction with the similarities between incidents resolved by those other responders and the incident.

In the case of content-based filtering, features of previously resolved incidents are used to provide the responder recommendation, such as the incident features described above. For example, similar incidents can be identified based on the tokens and the recommended responders can be those associated with the identified similar responders.

Using a content-based filtering model is premised on the principle that if a responder has solved a particular incident, the same responder might be able to solve a similar incident or a related incident. In an example, related incidents to an incident may be defined as a list of incidents that occurred within a specific time frame that includes the current incident. In an example, a similar incident to a current incident can be defined as one that has incident title token(s) common to the tokens collected from the current incident. Content-based filtering in case of Frequent incidents and in some cases if the incident is rare where the data is able to provide a profile of related and similar incidents. Using a collaborative filtering model is premised on the principle that if a responder has solved a particular incident, similar responders might be able to solve a similar incident or a related incident.

The responders associated with the similar incidents can be used to obtain the recommended responders. Using the fuzzed incident titles, for at least some (e.g., each) of the available responders (e.g., responders configured in the EMB), a collection of incidents that each of the responders was associated with is obtained (such as by querying the data store 410 of FIG. 4). Thus, a respective collection of incidents that a responder is associated with can be obtained based on the tokens of the incident titles. The respective collection of incidents can be obtained using techniques such as term frequency-inverse document frequency (TFIDF). For each of the incidents of the collection of incidents cosine similarities can be calculated. The responders associated with the cosine similarities that are greater than a similarity threshold can be identified as recommended responders.

Cosine similarities or cosine similarity is a metric used to measure the similarity between features of two items, documents, or the like, represented as feature vectors. The technique of cosine similarities measures the cosine of an angle between two vectors of data projected in multi-dimensional space. This measurement allows a measure the similarity of a document of any type, such as the incidents disclosed herein.

In one aspect, the responder recommendation tool may determine the incident type by evaluating the incident based on constituent data of the incident and historical data related to the incident.

In another aspect, the responder recommendation tool may, responsive to determining that the incident is of the rare type or the frequent type, generate the list of recommended responders based on fuzzed incident titles, historical data of past responders for the alert (or incident), a skillset needed (e.g., identified) to respond to the incident and/or responder skillset data.

In an aspect, fuzzed incident titles may be generated by a technique of converting an input value, such as an incident title, to a fuzzy value that is performed by the use of the information in a knowledge base or database. For example, and without limitation, an incident title of “Kubernetes services error type 3” may be “fuzzed” to be described as “containerized application services error.” Other examples may be possible depending on the amount of historical data collected on incidents in the network.

In another aspect, the list of recommended responders may be generated by executing a collaborative filtering model. The responder recommendation tool may analyze the processed data such as “fuzzed” or “tokenized” incidents parsed from the received incident; determine a history of who has responded to a recent incident or similar incident recently; analyze, if available, data on what knowledge is necessary to respond to the incident; if available, data on what skills responders have based on a profile of a responder in the recommendation engine. The list of recommended responders may include individual responders or teams (a group of responders represented by one entry in the list of recommended responders) determined to be qualified to respond, or at least helpful in responding, to the incident.

Tokenized incidents and incident titles may be generated for use in collaborative filtering algorithms. Tokenization, when applied to a title, may remove new lines, table spaces, and the like, and replace multiple consecutive white spaces with a single whitespace. Another example of tokenization may be when the recommendation engine processes an incident title, identifies any substring that may indicate a time (e.g., a date, a timestamp, a date and time) and replaces the time with the token (e.g., string) “datetime.” For example, given the title “Jan 31, 2021 10:35:34 – Service unavailable,” when tokenization is applied, may result in the normalized title “datetime – Service unavailable.” Another example of tokenization applied by the recommendation engine may identify special identifiers in the incident title and replace the identifiers with respective representative tokens. To illustrate, and without limitations, the recommendation engine when applying tokenization may identify, in an incident title, a substring (e.g., an identifier) as a universally unique identifier (UUID), a globally unique identifier (GUID), an Internet Protocol (IP) address, or a Uniform Resource Locator (URL) and replaces such identifiers with the representative tokens “uuid,” “uuid,” “ip_addr,” or “url,” respectively. For example, given the alert title “sparkline-replay-pixel_10_108_91_19 expired,” tokenization by the recommendation engine may obtain the normalized title “sparkline-replay-pixel_ip_addr expired.”

In an aspect, the responder recommendation tool may execute the collaborative filtering model by normalizing incident titles; determining a historical responder for each normalized title; and filtering the historical responder to generate a list of potential responders for the incident title. In an aspect, the responder recommendation tool may normalize incident titles may include “fuzzing” the incident titles and “tokenizing” the incident titles.

In an aspect, the responder recommendation tool may determine a historical responder may include generating a list of incidents with which the historical responder has interacted. In another aspect, responder recommendation tool may filter the historical responder by executing a term frequency-inverse document frequency algorithm to build a user profile of incident title words. The responder recommendation tool 418 may calculate, for each incident title word, cosine similarities.

In another aspect, the responder recommendation tool may determine that the incident is of the rare type or the frequent type and generate, the list of recommended responders by executing a content-based filtering model.

In an aspect, the responder recommendation tool 418 may execute the content-based filtering model by analyzing incidents selected from a list of incidents that were received or that were resolved over a specific time frame (such as a lookback window). The content-based filtering model may analyze incident title tokens common to title tokens related to the incident.

At 710, it is determined whether a selection of one or more recommended responders has been made. If so, the selected recommended responders are added to (e.g., associated with) the incident. Notifications may be transmitted to the selected recommended responders.

At 712, at least one of the content-based filtering model or the collaborative based filtering model may be retrained to improve their respective responder recommendations. The re-training can be performed in response to a retraining criterion being met. In an example, the retraining criterion can be related to the duration of time since the models were retrained. In an example, the models can be retrained according to a schedule (such as daily, weekly, monthly, or so on). In an example, the retraining criterion can be that a certain number of new incidents have been resolved since the previous retraining (or initial training). Retraining the models can use incident data, responder data, or both that may be in the data store 714, which can be the data store 410 of FIG. 4.

When addressing a rare type or frequent type incident, the responder recommendation tool may employ a “hybrid” approach with content-based filtering model and/or a collaborative filtering model recommend a responder, a list of responders or a team of responders, if any. It may occur that the recommended responder is no longer available, such as if the recommended responder has left the company, is on leave or vacation, or moved to a different group.

In an example, the responder recommendation tool may be configured to perform load balancing so that, for example, one or a very small number of responders are not recommended (based on their rankings) and added to a significant number of incidents. This may lead to assigning certain responders to incidents beyond their available work bandwidth, which in turn extends the time-to-resolution, and also leads to responder burn out. A configuration may indicate whether the technique 700 is to perform load balancing with respect to recommended responders. In another example, the list of recommended responders may be received at a load balancer (not shown), which can generate a list of load balanced list of responders.

A load-balanced list of responders may be obtained at 716. For example, the list of recommended responders obtained at 706 may be load balanced at 716 to obtain the load-balanced list of responders. Load balancing can include randomly excluding a highest ranked responder from the list of recommended responders. Load balancing can include randomly ordering, notwithstanding the ranks obtained at 708, the N top-most ranked recommended responders, where N is an integer that is greater than 2. Load balancing can include selecting a responder from a bottom tier (e.g., 70^{th} percentile) of the list of recommended responders and randomly inserting the responder in the top tier (e.g., the 30^{th} percentile) of the list of recommended responders. In an example, load balancing can itself be randomly performed. As such, load balancing may attempt to limit the number of times a particular responder is recommended based on the frequency of past recommendations of the particular responder or the number of times the particular responder has been recommended in a past time period, such as the past few months. Other load balancing techniques may be available.

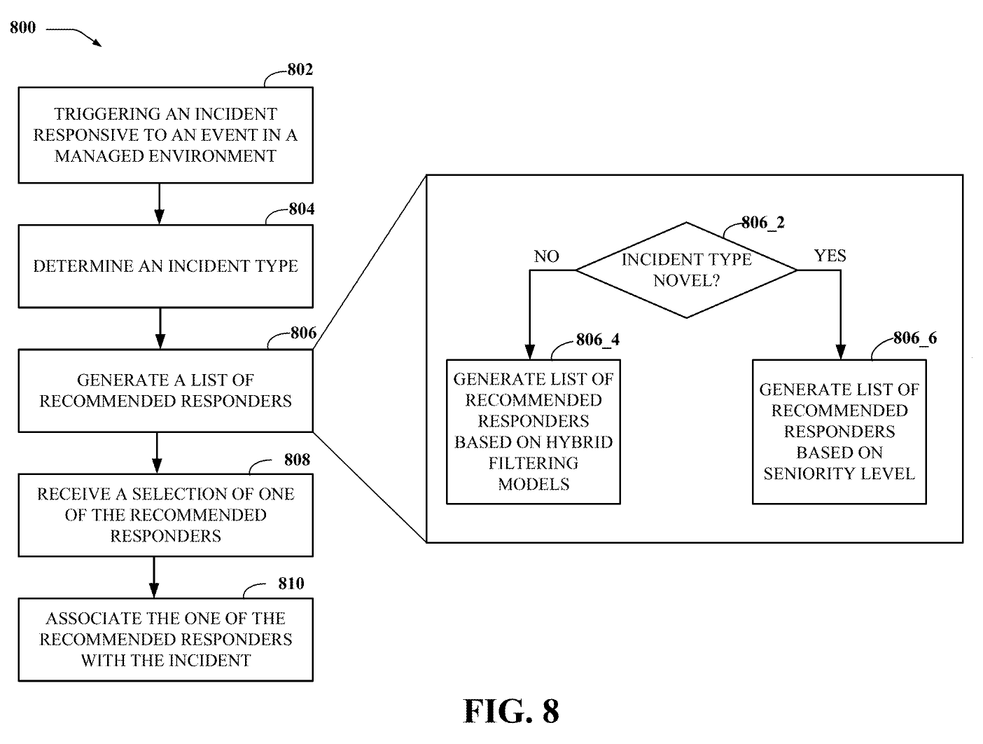

FIG. 8 is a flowchart of an example of a technique 800 for recommending responders. The technique 800 may be implemented in a system, such as the system 400 of FIG. 4. The technique 800 may be implemented by a responder recommendation tool, such as the responder recommendation tool 418 of FIG. 4. The actions illustrated in the flowchart of FIG. 8 may be implemented as executable instructions that may be stored in a memory, such as the memory 204 of FIG. 2 or the memory 304 of FIG. 3. The executable instructions may be executed by a processor, such as the processor 202 of FIG. 2 or the processor 302 of FIG. 3.

At 802, an incident that requires a resolution responsive to an event detected in a managed information technology environment is triggered. At 804, an incident type is determined for the incident. The incident type can be determined as described above. The incident type may be one of a rare type, a novel type, or a frequent type. In action 806, a list of responders is generated based on the type.

At 808, a selection of one of the recommended responders is received. For example, the list of recommended responders may be presented, such as in a user interface, to responder already associated with the incident. The list may be presented in rank order, as described herein. The responder already associated with the incident may select one or more of the recommended responders to associate with the incident. At 810, the one of the recommended responders is associated with the incident. As described above, associating a recommended responder with the incident can mean that the recommended responder is being brought in to help resolve the incident. In another example, by selecting a recommended responder, the responder already associated with the incident may transfer ownership of the incident to the recommended responder.

Generating the list of incidents at 806 includes, at 806_2, determining whether the incident type is the novel type. Responsive to determining that the incident is not the novel type (e.g., the incident type is the rare type or the frequent type), the technique 800 proceeds to 806_6 to generate a list of recommended responders based on historical data related to prior causes and a skillset of a responder available to address the incident. Responsive to determining that the incident is the novel type, the technique 800 proceeds to 806_6 to generate the list of recommended responders based on respective seniority levels of responders available to address the incident.

As such, responsive to determining that the incident is of the novel type, a machine-learning model recommendation engine generates the list of recommended responders based on a “hybrid model” of collaborative filtering models or content-based filtering models.

Some incident types (referred to herein as a rare type or a novel or frequent type) can be triggered from rarely occurring events or from newly discovered events, respectively. Incidents of the rare or the novel types may require the focused attention of responders and may require longer times to resolve as no institutional knowledge (or accumulated expertise) may be associated with such rare or novel incidents. As can be appreciated, less (if any) institutional knowledge may be associated with novel incidents than with rare incidents.

While the teachings herein are described with respect to classifying an incident (an event, an alert, an incident) as rare, novel, or frequent, the disclosure is not so limited. The teachings herein can be used to classify any datum into one or more categories (e.g., incident types) by matching one or more attributes associated with (e.g., of, related to, obtained for, derived from related entities to, etc.) the datum to an incident type and using historical data to determine a number of occurrences of the incident in the historical data wherein at least some of the historical data are associated with respective incidents.

In one aspect, the list of the recommended responders includes an entry representing a group of responders. In another aspect, the technique 800 may determine the incident type for the incident by, responsive to incident data meeting a first condition, determining that the incident is of the rare type. The technique 800 may, responsive to the incident data meeting a second condition, determine that the incident is of the novel type; and responsive to the incident data meeting a third condition, determine that the incident is of the frequent type.

In one aspect, the technique 800 may determine the incident type by evaluating the incident based on constituent data of the incident and historical data related to the incident.

In another aspect, the technique 800 may, responsive to determining that the incident is of the rare type or the frequent type, generate, by the machine-learning model recommendation engine, the list of recommended responders by generating the list of recommended responders based on fuzzed incident titles, historical data of past responders for the alert, a skillset needed to respond to the incident and/or responder skillset data.

In an aspect of the disclosed technique, executing the collaborative filtering model may include the actions of normalizing incident titles; determining a respective historical responder for each normalized title; and filtering the historical responder to generate a list of potential responders for the incident title. In an aspect, the action of normalizing incident titles may include “fuzzing” the incident titles and “tokenizing” the incident titles.

In an aspect of the disclosed technique, determining a historical responder may include generating a list of incidents with which the historical responder has interacted (i.e., is associated). In another aspect, the technique 800 may filter the historical responder by executing a term frequency-inverse document frequency algorithm to build a user profile of incident title words. The technique may calculate cosine similarities using the incident title words.

In another aspect, the technique 800 may determine that the incident is of the rare type or the frequent type and generate the list of the recommended responders by executing a content-based filtering model.

In an aspect, executing the content-based filtering model may include analyzing incidents selected from a list of incidents happening over a specific time frame. The content-based filtering model may analyze incident title tokens common to title tokens related to the incident.

The machine-learning model recommendation engine may generate an improved list as more data are collected related to incidents and skillsets of responders in the responder database. The recommendation engine may be retrained to generate lists of teams to recommend to respond to the incident in addition to or instead of individual responders.

The list of recommended responders may be transmitted to a load balancer. The load balancer may be employed to manage a dedication of resources of the responder recommendation tool 418 to address and respond to the alerts. The load balancer may be configured to avoid the selection of the same responder too many times over a specific time period, or every time a particular incident type may occur. A load-balanced list of recommended responders is obtained from the load balancer. The load-balanced list of recommended responders may be presented to a current responder. As such, receiving a selection of one of the recommended responders can mean or include receiving a selection of one of the recommended responders where the one of the recommended responders is included in the load-balanced list of recommended responders.

For simplicity of explanation, the techniques in FIGS. 5, 7, and FIG. 8 are each depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The phrase “in one aspect” as used herein does not necessarily refer to the same aspect, though it may. Furthermore, the phrase “in another aspect” as used herein does not necessarily refer to a different aspect, although it may. Thus, as described below, various aspects may be readily combined, without departing from the scope or spirit of the disclosure.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example aspects, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java™, PHP, Perl, JavaScript, Ruby, VBScript, Microsoft .NET™ languages such as C#, and/or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage devices and be stored on and executed by one or more general purpose computers, thus creating a special purpose computer configured to provide the engine.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device. Other suitable mediums are also available. Such computer-usable or computer readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

The sequence diagram in FIG. XXX may be encoded in a signal bearing medium, a computer readable medium such as a memory, programmed within a device such as one or more integrated circuits, or processed by a controller or a computer. If the methods are performed by software, the software may reside in a memory resident to or interfaced to the any type of non-volatile or volatile memory interfaced or resident to the memory incorporated in the components of the computing environment 100. Such memory may include an ordered listing of executable instructions for implementing logical functions. A logical function may be implemented through digital circuitry, through source code, through analog circuitry, or through an analog source such through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A "computer-readable medium," "machine-readable medium," "propagated-signal" medium, and/or "signal-bearing medium" may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection "electronic" having one or more wires, a portable magnetic or optical disk, a volatile memory such as a Random Access Memory “RAM” (electronic), a Read-Only Memory "ROM" (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various aspects of the disclosure have been described, it will be apparent to those of ordinary skill in the art that many more aspects and implementations are possible within the scope of the disclosure. Accordingly, the disclosure is not to be restricted except in light of the attached claims and their equivalents.

What is claimed is:

1. A method for managing event data in an event management system, the method comprising:
configuring an event management bus to ingest one or more events from a plurality of event sources limited to a defined acceptance rate;
rejecting, in response to determining that a received event is not received in accordance with the defined acceptance rate, the received event;
transmitting, in response to the determining, a rejection notification to a system from which the received event was received, wherein the rejection notification indicates that the received event is not accepted for processing; and
triggering, for an event ingested in accordance with the defined acceptance rate, an incident,
initiating, based on an output from a machine-learning model, a process for identifying a resolution for the incident, wherein the machine-learning model is selected based on an incident type determined for the incident;
executing an action determined as a result of the initiated process by an action execution tool;
receiving, from the action execution tool, feedback data indicating an effectiveness of the executed action in resolving the incident; and
retraining the machine-learning model using the feedback data.

2. The method of claim 1, wherein the incident type is selected from a set comprising a rare type, a novel type, and a frequent type.

3. The method of claim 2, further comprising:
determining the incident type for the incident by:
responsive to incident data meeting a first condition, determining that the incident is of the rare type;
responsive to the incident data meeting a second condition, determining that the incident is of the novel type; and
responsive to the incident data meeting a third condition, determining that the incident is of the frequent type.

4. The method of claim 3, wherein determining the incident type further comprises:
evaluating the incident based on constituent data of the incident and historical data related to the incident.

5. The method of claim 2, wherein the machine-learning model is a collaborative filtering model when the incident is of the frequent type and is a content-based filtering model when the incident is of the rare type.

6. The method of claim 5, further comprising executing the collaborative filtering model, the collaborative filtering model including normalizing an incident title associated with the incident to identify one or more similar historical incidents.

7. The method of claim 6, wherein normalizing the incident title comprises tokenizing the incident title and replacing specific types of information with representative tokens, wherein the specific types of information comprises at least one of a timestamp, a unique identifier, or a network address.

8. The method of claim 6, wherein the collaborative filtering model further includes:
executing a term frequency-inverse document frequency algorithm to build a user profile of one or more incident title words from the normalized incident title; and
calculating cosine similarities using the one or more incident title words.

9. The method of claim 2, wherein the machine-learning model is a content-based filtering model, the method further comprising executing the content-based filtering model, the content-based filtering model including:
analyzing one or more incidents selected from a list of incidents occurring over a specific time frame; or
analyzing one or more incident title tokens common to title tokens related to the incident.

10. The method of claim 1, wherein at least some of the one or more events are ingested via one of a Short Message Service (SMS) message, a HyperText Transfer Protocol (HTTP) request, or an Application Programming Interface (API) call.

11. A method for managing event data in an event management system, the method comprising:
configuring an event management bus to ingest one or more events at a defined acceptance rate and to reject any event received in excess of the defined acceptance rate;
classifying, for an ingested event, a corresponding incident as one of at least a frequent type or a rare type;
executing, responsive to the incident being classified as the frequent type, a collaborative filtering model to initiate a process to identify an action for resolving the incident;
executing, responsive to the incident being classified as the rare type, a content-based filtering model to initiate a process to identify the action for resolving the incident;
tracking feedback data resulting from the action being carried out;
retraining at least one of the collaborative filtering model or the content-based filtering model using the feedback data to improve one or more later action recommendations.

12. The method of claim 11, wherein executing the collaborative filtering model comprises normalizing an incident title associated with the incident.

13. The method of claim 12, wherein normalizing the incident title comprises tokenizing the incident title and replacing specific types of information with representative tokens, wherein the specific types of information comprises at least one of a timestamp, a unique identifier, or a network address.

14. The method of claim 11, wherein executing the collaborative filtering model further comprises:
executing a term frequency-inverse document frequency algorithm to build a user profile of one or more incident title words; and
calculating cosine similarities using the one or more incident title words.

15. The method of claim 11, wherein executing the content-based filtering model comprises at least one of:
analyzing one or more incidents selected from a list of incidents occurring over a specific time frame; or
analyzing one or more incident title tokens common to title tokens related to the incident.

16. A method for improving incident response, the method comprising:
configuring an event management bus to ingest one or more received events, wherein each received event indicates a condition detected by a monitoring tool;
determining, responsive to an ingested event, an incident type for a corresponding incident from a set comprising at least one of a frequent type or a rare type;
generating, by a machine-learning model, a recommendation for resolving the incident, wherein the machine-learning model is selected based on the determined incident type and the generating includes:
normalizing incident titles by tokenizing the incident titles and replacing specific types of information with representative tokens, wherein the specific types of information includes timestamps, unique identifiers, and network addresses,
executing a collaborative filtering model using the normalized incident titles to identify similar historical incidents, wherein the collaborative filtering model is trained based on features of incidents in a historical data set,
calculating cosine similarities between the incident and the similar historical incidents, and
generating the recommendation based on the cosine similarities and the similar historical incidents;
executing an action determined as a result of the recommendation by an action execution tool;
receiving, from the action execution tool, feedback data indicating an effectiveness of the executed action in resolving the incident; and
retraining the machine-learning model using the feedback data.

17. The method of claim 16, wherein determining the incident type comprises:
responsive to historical data meeting a first condition, determining that the incident is of the rare type; and
responsive to the historical data meeting a second condition, determining that the incident is of the frequent type.

18. The method of claim 17, wherein determining the incident type further comprises evaluating the incident based on constituent data of the incident and the historical data related to the incident.

19. The method of claim 16, wherein at least some of the one or more received events are ingested via one of a Short Message Service (SMS) message, a HyperText Transfer Protocol (HTTP) request, or an Application Programming Interface (API) call.

20. The method of claim 16, wherein the machine-learning model is the collaborative filtering model when the incident is of the frequent type, and wherein the machine-learning model is a content-based filtering model when the incident is of the rare type.
